(19) United States
(12) Patent Application Publication
(10) Pub. No.: US 2025/0271738 A1
(43) Pub. Date: Aug. 28, 2025

(54) LIGHT SOURCE SYSTEM AND PROJECTION DEVICE

(71) Applicant: Coretronic Corporation, Hsin-Chu (TW)

(72) Inventors: Yao-Shun Lin, Hsin-Chu (TW); Chia-Hao Wang, Hsin-Chu (TW); Bo-Heng Zhou, Hsin-Chu (TW)

(73) Assignee: Coretronic Corporation, Hsin-Chu (TW)

(21) Appl. No.: 19/043,504

(22) Filed: Feb. 2, 2025

(30) Foreign Application Priority Data
Feb. 26, 2024 (CN) 202410205719.2

(51) Int. Cl. G03B 21/20

(52) U.S. Cl. CPC G03B 21/204; G03B 21/208

(57) ABSTRACT

A light source system includes laser and excitation light source modules providing first and second light beams respectively, a light-combining element, a first light homogenizing element, a wavelength conversion element, and a second light homogenizing element. The first light homogenizing element has a deflection angle on a plane perpendicular to an optical axis of the second light beam. The light-combining element forms a combined light beam from the first light beam and the second light beam. The second light homogenizing element receives the combined light beam and generates an illumination light beam. A light spot formed by the fluorescent light beam on a light incident surface of the second light homogenizing element has a first shape, and the first shape corresponds to the shape of the light incident surface of the second light homogenizing element.

### CROSS-REFERENCE TO RELATED APPLICATION

This application claims the priority benefit of China application serial no. 202410205719.2, filed on Feb. 26, 2024. The entirety of the above-mentioned patent application is hereby incorporated by reference herein and made a part of this specification.

### BACKGROUND

### Technical Field

The disclosure relates to a light source system and a projection device.

### Description of Related Art

Recently, projection devices based on solid-state light sources such as lasers have gradually matured in the market. The laser diode (LD) has become the mainstream light source of modern projectors due to its advantages such as high collimation, high light intensity, and the ability to converge light sources.

However, since the laser beam provided by the laser diode is coherent light, when the laser beam irradiates the uneven surfaces of the elements in the projection device (such as lenses, reflectors, etc.), the uneven surfaces of the objects will cause the reflected, refracted, or scattered light to form optical path differences between each other, forming interference phenomena in space and in turn producing spot-like speckles on the irradiated surface, or color blocks with uneven brightness and uneven color, thereby causing the image quality of the projection device to decline. In addition, since the high light intensity and high collimation of the laser light source also make it relatively difficult to homogenize the laser beam provided by the laser light source, the above-mentioned problems still need to be solved.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

An embodiment of the disclosure provides a light source system. The light source system includes a laser light source module, an excitation light source module, a light-combining element, a first light homogenizing element, a wavelength conversion element, and a second light homogenizing element. The laser light source module is configured to provide a first light beam, the excitation light source module is configured to provide a second light beam, and the light-combining element is disposed on a transmission path of the first light beam and the second light beam. The first light homogenizing element is disposed between the excitation light source module and the light-combining element and configured to receive and homogenize the second light beam from the excitation light source module so as to transmit the second light beam to the light-combining element. A light exit surface of the first light homogenizing element has a first shape. The wavelength conversion element is configured to receive the second light beam from the light-combining element and convert the second light beam into a fluorescent light beam. The light-combining element is disposed between the first light homogenizing element and the wavelength conversion element to guide the fluorescent light beam from the wavelength conversion element and the first light beam from the laser light source module, so that the first light beam and the fluorescent light beam form a combined light beam. The second light homogenizing element is disposed on a transmission path of the combined light beam and configured to receive the combined light beam and generate an illumination light beam. A light spot formed by the fluorescent light beam on a light incident surface of the second light homogenizing element has the first shape. A shape of the light incident surface of the second light homogenizing element is a second shape. The first shape substantially corresponds to the second shape. The first light homogenizing element has a deflection angle on a plane perpendicular to an optical axis of the second light beam.

An embodiment of the disclosure provides a projection device. The projection device includes a light source system, a light valve, and a projection lens. The light source system includes a laser light source module, an excitation light source module, a light-combining element, a first light homogenizing element, a wavelength conversion element, and a second light homogenizing element. The laser light source module is configured to provide a first light beam, the excitation light source module is configured to provide a second light beam, and the light-combining element is disposed on a transmission path of the first light beam and the second light beam. The first light homogenizing element is disposed between the excitation light source module and the light-combining element and configured to receive and homogenize the second light beam from the excitation light source module so as to transmit the second light beam to the light-combining element. A light exit surface of the first light homogenizing element has a first shape. The wavelength conversion element is configured to receive the second light beam from the light-combining element and convert the second light beam into a fluorescent light beam. The light-combining element is disposed between the first light homogenizing element and the wavelength conversion element and configured to guide the fluorescent light beam from the wavelength conversion element and the first light beam from the laser light source module, so that the first light beam and the fluorescent light beam form a combined light beam. The second light homogenizing element is disposed on a transmission path of the combined light beam and configured to receive the combined light beam and generate an illumination light beam. A light spot formed by the fluorescent light beam on a light incident surface of the second light homogenizing element has the first shape. A shape of the light incident surface of the second light homogenizing element is a second shape. The first shape substantially corresponds to the second shape. The first light homogenizing element has a deflection angle on a plane perpendicular to an optical axis of the second light beam. The light valve is disposed on a transmission path of the illumination light beam of the light source system and configured to convert the illumination light beam into an image light beam. The projection lens is disposed on a transmission path of the image light beam and configured to project the image light beam out of the projection device.

In order to make the above-mentioned features and advantages of the disclosure clearer and easier to understand, the following embodiments are given and described in details with accompanying drawings as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic structural view of a light source system according to an embodiment of the disclosure.

FIG. 1B and FIG. 1C are respectively a schematic side view of the first light homogenizing element and a schematic top view of the second light homogenizing element in FIG. 1A.

FIG. 2 is a schematic structural view of a light source system according to another embodiment of the disclosure.

FIG. 3A is a schematic view of a principle of the depolarizer in FIG. 2.

FIG. 3B is a schematic view of a polarization state distribution of the combined light beam in FIG. 3A after passing through the depolarizer.

FIG. 3C is a schematic structural view of the depolarizer and the second light homogenizing element in FIG. 2.

FIG. 4 is a schematic structural view of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a light source system that can provide an illumination light beam with good uniformity.

The disclosure provides a projection device that can reduce a phenomenon of speckle or color block in a display image and effectively improve the quality of the display image.

Other objects and advantages of the disclosure can be further understood from the technical features disclosed in the disclosure.

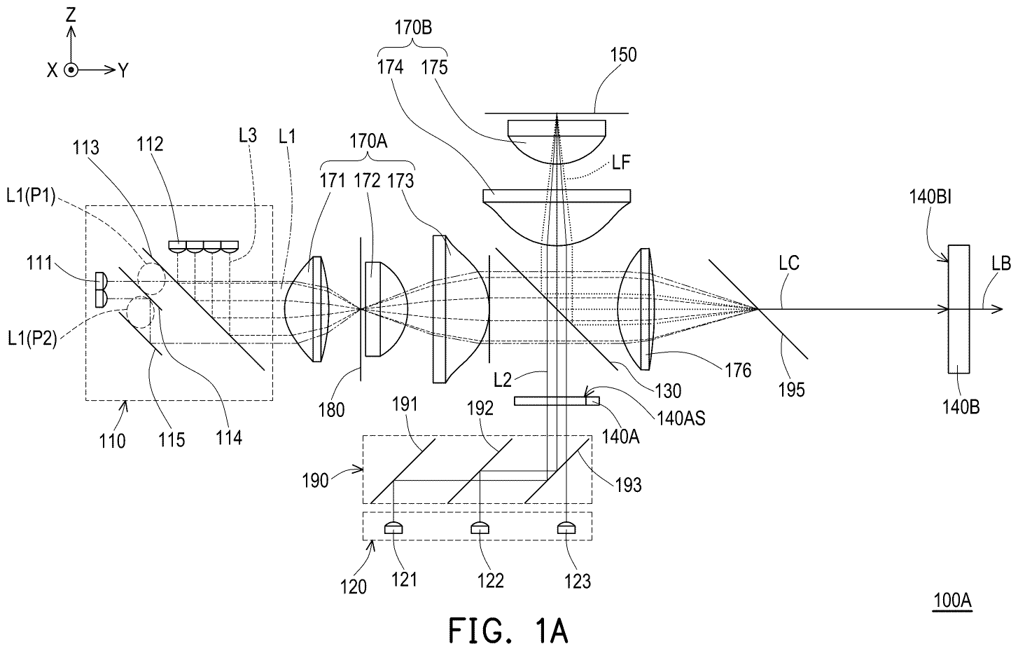

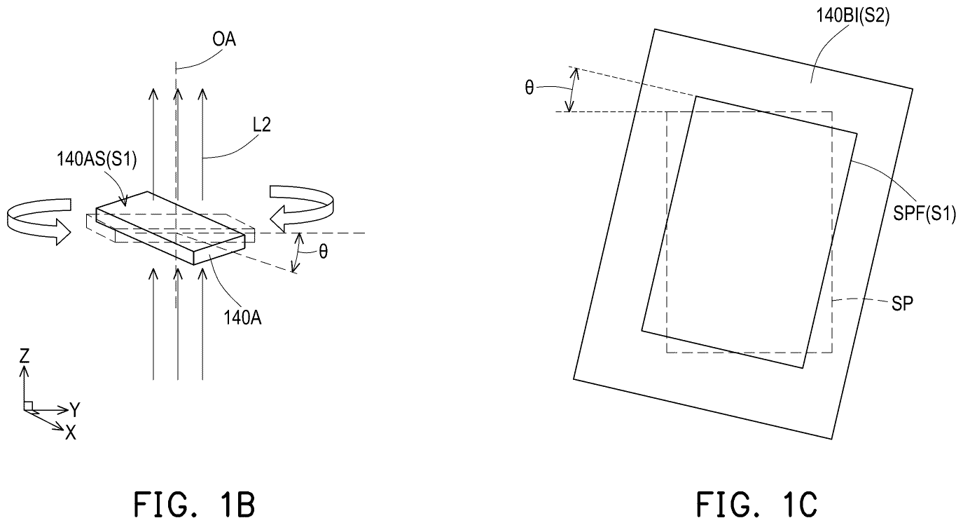

FIG. 1A is a schematic structural view of a light source system according to an embodiment of the disclosure. FIG. 1B and FIG. 1C are respectively a schematic side view of the first light homogenizing element and a schematic top view of the second light homogenizing element in FIG. 1A. Referring to FIG. 1A to FIG. 1C at the same time, a light source system 100A includes a laser light source module 110, an excitation light source module 120, a light-combining element 130, a first light homogenizing element 140A, a wavelength conversion element 150, and a second light homogenizing element 140B. The laser light source module 110 is configured to provide a first light beam L1. The excitation light source module 120 is configured to provide a second light beam L2. The light-combining element 130 is disposed on a transmission path of the first light beam L1 and the second light beam L2 and disposed between a first light homogenizing element 140A and the wavelength conversion element 150. The first light homogenizing element 140A is disposed between the excitation light source module 120 and the light-combining element 130. The first light homogenizing element 140A is configured to receive and homogenize the second light beam L2 from the excitation light source module 120 so as to transmit the second light beam L2 to the light-combining element 130. A light exit surface 140AS of the first light homogenizing element 140A has a first shape S1. The wavelength conversion element 150 is configured to receive the second light beam L2 from the light-combining element 130 and convert the second light beam L2 into a fluorescent light beam LF. The light-combining element 130 is configured to guide the fluorescent light beam LF from the wavelength conversion element 150 and the first light beam L1 from the laser light source module 110, so that the first light beam L1 and the fluorescent light beam LF form a combined light beam LC. The second light homogenizing element 140B is disposed on a transmission path of the combined light beam LC and configured to receive the combined light beam LC and generate an illumination light beam LB. A light spot SPF formed by the fluorescent light beam LF on a light incident surface 140BI of the second light homogenizing element 140B has the first shape S1. A shape of the light incident surface 140BI of the second light homogenizing element 140B is a second shape S2. The first shape S1 substantially corresponds to the second shape S2. The first light homogenizing element 140A has a deflection angle θ on a plane perpendicular to an optical axis OA of the second light beam L2.

In an embodiment, the laser light source module 110 and the excitation light source module 120 may include one or a plurality of laser light sources, and the first light beam L1 and the second light beam L2 are, for example, blue laser beams. Each of the laser light sources of the laser light source module 110 and the excitation light source module 120 may include one or a plurality of blue laser diodes arranged in an array, where each laser light source may be, for example, a multi-die laser package. For example, the laser light source module 110 in FIG. 1A can include two adjacent blue laser light sources 111, and the excitation light source module 120 can include three blue laser light sources 121 to 123 that are disposed separately from each other. However, the disclosure is not limited thereto.

The light-combining element 130 may be a partially transmitting and partially reflecting element, a dichroic mirror, a polarization beam-splitting element, or other elements that can split light beams. For example, in the embodiment, the light-combining element 130 can, for example, allow the first light beam L1 and the second light beam L2 in the blue light wavelength band to pass through and reflect the fluorescent light beam LF of other colors (such as red, green, yellow, etc.), or for example, allow light beams in the red and blue light wavelength bands to pass through and reflect the fluorescent light beam LF of other colors (such as green, yellow, etc.). In this way, the second light beam L2 can pass through the light-combining element 130 and be incident on the wavelength conversion element 150. However, the disclosure is not limited thereto.

The first light homogenizing element 140A and the second light homogenizing element 140B may be, for example, lens arrays or so-called fly eye lenses, but the disclosure is not limited thereto. In other embodiments, the first light homogenizing element 140A may be, for example, an assembly of an integration rod and a lens element. Furthermore, the first light homogenizing element 140A is configured to receive and homogenize the second light beam L2 from the excitation light source module 120 so as to transmit the second light beam L2 to the light-combining element 130, thereby reducing the problem of speckle of the second light beam L2.

The wavelength conversion element 150 can be, for example, a phosphor wheel. The second light beam L2 of blue color light from the excitation light source module 120 can pass through the first light homogenizing element 140A and the light-combining element 130 and further be projected on the light conversion area (not shown) of the phosphor wheel to excite the fluorescent light beams LF of different color light such as yellow, green, or red at different time intervals. The fluorescent light beam LF may be further reflected by the light-combining element 130, so that the first light beam L1 and the fluorescent light beam LF may be combined into a combined light beam LC with white color. By disposing the first light homogenizing element 140A on a light exit side of the excitation light source module 120, a light spot area formed on the wavelength conversion element 150 after the second light beam L2 passes through the first light homogenizing element 140A can be increased, thereby improving the light conversion efficiency of the wavelength conversion element 150.

In the embodiment of the disclosure, the first light homogenizing element 140A has the deflection angle θ such that the shape (i.e., the first shape S1) of the light spot SPF formed by the fluorescent light beam LF corresponds to the shape (i.e. the second shape S2) of the light incident surface 140BI of the second light homogenizing element 140B, so that the fluorescent light beam LF can further improve the uniformity through the second light homogenizing element 140B.

Referring to FIG. 1A and FIG. 1C, specifically, the light exit surface 140AS of the first light homogenizing element 140A may have the first shape S1, for example, a substantially rectangular shape. Therefore, the second light beam L2 will be homogenized after passing through the first light homogenizing element 140A to produce a light spot that has the same shape as the shape (i.e., the first shape S1) of the light exit surface 140AS of the first light homogenizing element 140A. Accordingly, the second light beam L2 passing through the first light homogenizing element 140A is irradiated to the wavelength conversion element 150, and the wavelength conversion element 150 generates the fluorescent light beam LF. After transmitting, the light spot SPF formed by the fluorescent light beam LF on the light incident surface 140BI of the second light homogenizing element 140B also has the corresponding first shape S1.

On the other hand, the light incident surface 140BI of the second light homogenizing element 140B has the second shape S2, which is also substantially rectangular, for example. In the existing art, after the fluorescent light beam is reflected or refracted by different elements in the light source system, a shape of a light spot SP (as shown in FIG. 1C) formed usually does not exactly correspond to the light incident surface of the second light homogenizing element. In the embodiment of the disclosure, the first light homogenizing element 140A is deflected by the fixed deflection angle θ, that is, on a plane perpendicular to the optical axis OA of the second light beam L2 (such as the plane where direction X and direction Y are located, that is, the X-Y plane), by using the optical axis OA as the axis of rotation and deflecting the first light homogenizing element 140A by the deflection angle θ, the first shape S1 can also be deflected by the deflection angle θ such that the first shape S1 and the second shape S2 correspond to each other. Or it can also be understood that the first light homogenizing element 140A has the deflection angle θ, which can make a long side of the first shape S1 be substantially parallel to a long side of the second shape S2 and a short side of the first shape S1 be substantially parallel to a short side of the second shape S2 such that the first shape S1 and the second shape S2 correspond to each other.

Through the above configuration, compared with the light spot SP generated by the second light beam when the first light homogenizing element does not have the deflection angle in the existing art, the light spot SPF formed by the fluorescent light beam LF on the light incident surface 140BI of the second light homogenizing element 140B is deflected by the deflection angle θ in the embodiment, such that the first shape S1 substantially corresponds to the second shape S2. In this way, the fluorescent light beam LF can match the light incident surface 140BI of the second light homogenizing element 140B to reduce light energy loss, so that the number of reflections of the fluorescent light beam LF in the second light homogenizing element 140B is increased to improve the uniformity of the illumination light beam LB, thereby increasing the efficiency of the light source system 100A and also improving the uniformity of color and brightness of the image light beam when the light source system 100A is used in a projection device.

In the embodiment, the first light homogenizing element 140A is illustrated using a lens array as an example. However, in an embodiment (not shown) in which the first light homogenizing element 140A is an assembly of an integration rod and a lens element, the deflection angle θ of the first light homogenizing element 140A can be replaced by deflecting the integration rod. For example, with an optical axis of the second light beam L2 entering the integration rod as the center, the integration rod is rotated along a plane perpendicular to a transmission direction of the second light beam L2, so that the long side of the first shape S1 is substantially parallel to the long side of the second shape S2 and the short side of the first shape S1 is substantially parallel to the short side of the second shape S2, but the disclosure is not limited thereto. In some embodiments, the above-mentioned deflection angle θ may be greater than 0 degrees and less than or equal to 10 degrees. In some embodiments, the deflection angle θ may be substantially 7.5 degrees, but the disclosure is not limited thereto.

Referring to FIG. 1A, in some embodiments, in addition to having the laser light source 111 for generating the first light beam L1, the laser light source module 110 may also include an auxiliary light source beam splitter 113 and an auxiliary light source 112 for providing a third light beam L3. The auxiliary light source 112 is, for example, a red laser light source. The auxiliary light source may include one or a plurality of red laser diodes arranged in an array, and the third light beam L3 emitted by the auxiliary light source 112 is red light with the wavelength band that can pass through the light-combining element 130, but the disclosure is not limited thereto. Furthermore, the wavelength band of the red light of the third light beam L3 provided by the auxiliary light source 112 is different from the wavelength band of the red light of the fluorescent light beam LF generated by the wavelength conversion element 150. Therefore, the light-combining element 130 can be equipped with an optical element designed to allow the third light beam L3 emitted by the auxiliary light source 112 to pass through and reflect the fluorescent light beam LF. The auxiliary light source beam splitter 113 is disposed on a transmission path of the first light beam L1 and the third light beam L3, and configured to reflect the third light beam L3 and allow the first light beam L1 to pass through. The first light beam L1, the third light beam L3, and the fluorescent light beam LF pass through the light-combining element 130 to form the combined light beam LC. The auxiliary light source 112 can be regarded as a supplementary light source to further enhance the color purity of the red light in the combined light beam LC. The auxiliary light source beam splitter 113 may be a partially transmitting and partially reflecting element, a dichroic mirror, a polarization beam-splitting element, or other elements that can split light beams. The disclosure is not limited thereto.

In some embodiments, the number of the auxiliary light sources 112 may be greater than the number of the laser light sources 111. In FIG. 1A, four auxiliary light sources 112 and two laser light sources 111 are used as an example. However, the disclosure is not limited thereto. The laser light source module 110 further includes a first beam splitter 114 and a second beam splitter 115. The first beam splitter 114 is disposed on a transmission path of the first light beam L1 from the laser light source 111 to the auxiliary light source beam splitter 113. The first light beam L1 includes a first part P1 and a second part P2. The first beam splitter 114 is configured to allow the first part P1 of the first light beam L1 to pass through and reflect the second part P2 of the first light beam L1. The second beam splitter 115 is disposed on a transmission path of the second part P2 of the first light beam L1 and configured to reflect the second part P2 of the first light beam L1, so that the second part P2 of the first light beam L1 is transmitted to the auxiliary light source beam splitter 113.

For example, the first beam splitter 114 may have corresponding transmission areas and reflection areas. The first part P1 of the first light beam L1 is a light beam that irradiates the transmission area of the first beam splitter 114 and passes through the first beam splitter 114. The second part P2 of the first light beam L1 is a light beam that irradiates the reflection area of the first beam splitter 114 and is transmitted to the second beam splitter 115, and then transmitted in the direction Y to pass through the auxiliary light source beam splitter 113 after being reflected by the second beam splitter 115.

Since the cost of the laser light source 111 of the solid-state laser is relatively high, in a configuration where the number of the auxiliary light sources 112 is greater than the number of the laser light sources 111, through the beam splitting and beam expansion of the first beam splitter 114 and the second beam splitter 115, the area of the light spot (not shown) formed by the first part P1 and the second part P2 of the first light beam L1 can be substantially the same as the area of the light spot (not shown) formed by the auxiliary light source 112. In this way, not only the number of the laser light sources 111 can be saved, but also the combined light efficiency of the first light beam L1 and the third light beam L3 can be effectively improved and the cost can be reduced. In some embodiments, if the number of the auxiliary light sources 112 is the same as the number of the laser light sources 111, the first beam splitter 114 and the second beam splitter 115 may not be disposed, but the disclosure is not limited thereto.

In other embodiments, the arrangement positions of the laser light source 111 and the auxiliary light source 112 can be relatively replaced. Correspondingly, the auxiliary light source beam splitter 113 can be replaced with a beam splitter that reflects blue light and allows red light to pass through, and the first beam splitter 114 and the second beam splitter 115 can also be correspondingly replaced to reflect the second part of the third light beam L3 of red light, but the disclosure is not limited thereto.

In some embodiments, the light source system 100A further includes a first lens group 170A and a second lens group 170B. For example, the first lens group 170A may include a first lens 171, a second lens 172, and a third lens 173, and the first lens group 170A is disposed between the laser light source module 110 and the light-combining element 130. The second lens group 170B may include a fourth lens 174 and a fifth lens 175 disposed between the wavelength conversion element 150 and the light-combining element 130.

In some embodiments, the light source system 100A may also include a speckle elimination element. For example, the light source system 100A may include a diffusion element 180 disposed between the laser light source module 110 and the light-combining element 130. For example, the diffusion element 180 may be disposed between the first lens 171 and the second lens 172, and may be disposed near the focal position of the first lens 171, but the disclosure is not limited thereto. The first light beam L1 and the third light beam L3 can eliminate a phenomenon of speckle generated in the laser light source through the diffusion element 180. While the first light beam L1 and the third light beam L3 are easily diverged due to diffusion after passing through the diffusion element 180, the second lens 172 and the third lens 173 can converge the first light beam L1 and the third light beam L3 and effectively guide them to the light-combining element 130. In some embodiments, the diffusion element 180 may be an actuating diffusion sheet. For example, a light incident surface of the diffusion element 180 can be substantially perpendicular to a transmission direction (for example, the direction Y) of the first light beam L1 and the third light beam L3, and the diffusion element 180 can reciprocate on an imaginary plane (for example, the plane where the direction X and the direction Z are located together, that is, the X-Z plane), thereby enhancing the effect of the diffusion element 180 on eliminating speckles. In some embodiments, the diffusion element 180 can also be a diffusion wheel, and the effect of the diffusion element 180 on eliminating speckles can be enhanced through the rotation of the diffusion wheel, and the risk of burning the diffusion element 180 due to the first light beam L1 and the third light beam L3 being irradiated for too long can also be reduced, but the disclosure is not limited thereto.

Since the combined light loss of the light-combining element 130 is less, with the second lens group 170B, the fluorescent light beam LF converted by the wavelength conversion element 150 can be effectively gathered or converged, and then reflected by the light-combining element 130, so that the efficiency of the light source system 100A can be further increased. The light source system 100A may further include a sixth lens 176, which is disposed between the light-combining element 130 and the second light homogenizing element 140B to further converge the combined light beam LC formed by the first light beam L1, the third light beam L3, and the fluorescent light beam LF, so that the light-emitting efficiency of the light source system 100A can also be increased. The above-mentioned lenses 171 to 176 may all be converging lenses with positive diopter, but the disclosure is not limited thereto. In other embodiments, lenses with different diopters can also be configured to provide the light pattern correction.

Referring to FIG. 1A, on the other hand, in some embodiments, the light source system 100A may also include a light-combining module 190, which is disposed on the light exit side of the excitation light source module 120 to combine a plurality of light beams emitted by the excitation light source module 120 into the second light beam L2.

In detail, the light-combining module 190 may include a reflector 191 and light-combining mirrors 192 and 193, which are respectively disposed corresponding to the light exit sides of the laser light sources 121 to 123 in the laser light source module 120. Each light-combining mirror 192 and 193 may have a corresponding transmission area and a reflection area respectively. The transmission area allows the light beams emitted by the laser light sources 122 and 123 to pass through, and the reflection area allows the light beams emitted by the laser light sources 122 and 123 to reflect. For example, the light beam emitted by the laser light source 121 can be reflected by the reflector 191 to transfer along the direction Y and correspondingly pass through the transmission area of the light-combining mirror 192. The light beam emitted by the laser light source 122 can be reflected on the reflection area of the light-combining mirror 192 and then transfers along the direction Y. Similarly, the plurality of light beams emitted by the laser light sources 121 and 122 can be reflected on the reflection area of the light-combining mirror 193 to transfer along the direction Z, and the light beam emitted by the laser light source 123 can pass through the transmission area of the light-combining mirror 193 to transfer along the direction Z. Accordingly, the plurality of light beams emitted by the laser light sources 121 to 123 finally all transfer along the direction Z to form the second light beam L2 and pass through the first light homogenizing element 140A. Through the above configuration, the light-combining module 190 can be configured to combine the plurality of light beams emitted by the excitation light source module 120, so that the light spot area formed by the second light beam L2 irradiating the wavelength conversion element 150 can be increased to improve the conversion efficiency.

In some embodiments, the light source system 100A may also include a reflector 195. The reflector 195 is, for example, a folding mirror, and can adjust the light emission direction of the combined light beam LC. For example, in an embodiment, the reflector 195 can change the transmission direction of the combined light beam LC from the direction Y to the direction X (corresponding to the direction mark in FIG. 1A), but the disclosure is not limited thereto. It should be noted that when the transmission direction of the combined light beam LC changes to the direction X, the second light homogenizing element 140B will also be correspondingly adjusted to the transmission direction of the combined light beam LC.

Other embodiments will be enumerated below to describe the disclosure in detail, in which identical reference numerals indicate identical components, and repeated descriptions of the same technical contents are omitted. For the detailed description of the omitted parts, reference can be found in the previous embodiment, and no repeated description is contained in the following embodiments.

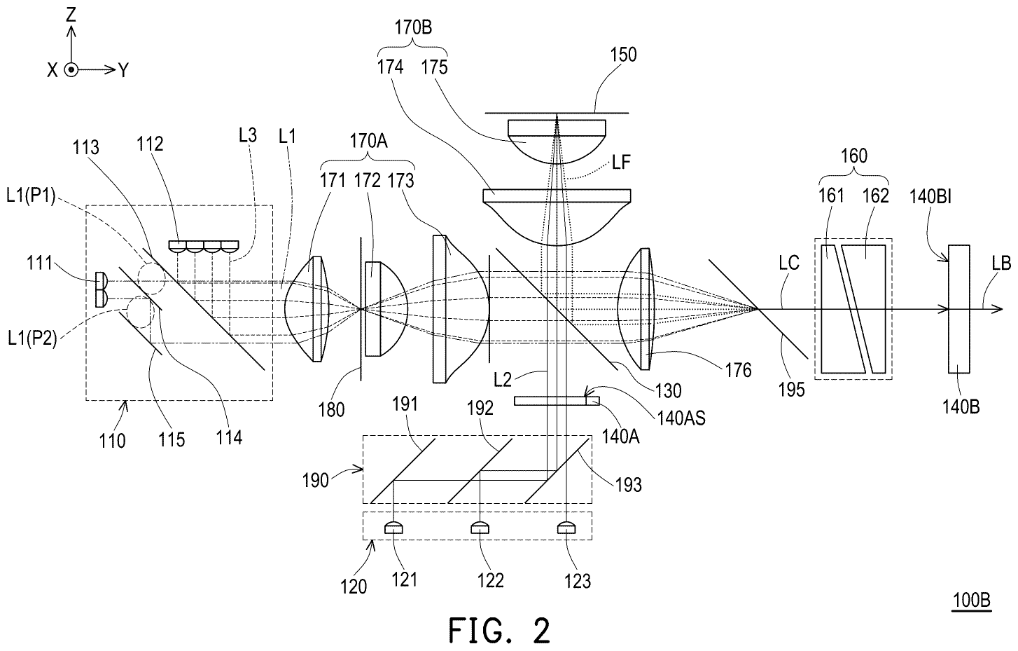

FIG. 2 is a schematic structural view of a light source system according to another embodiment of the disclosure. Referring to FIG. 2, a light source system 100B is similar to the light source system 100A of FIG. 1A. The following differences are that the light source system 100B also includes a depolarizer 160, which is disposed on the transmission path of the combined light beam LC, and the depolarizer 160 is located between the light-combining element 130 and the second light homogenizing element 140B. The depolarizer 160 can further make the polarization state distribution of the combined light beam LC uniform and alleviate the problem of uneven brightness and color in the display image of the laser projection device, which will be described in detail later.

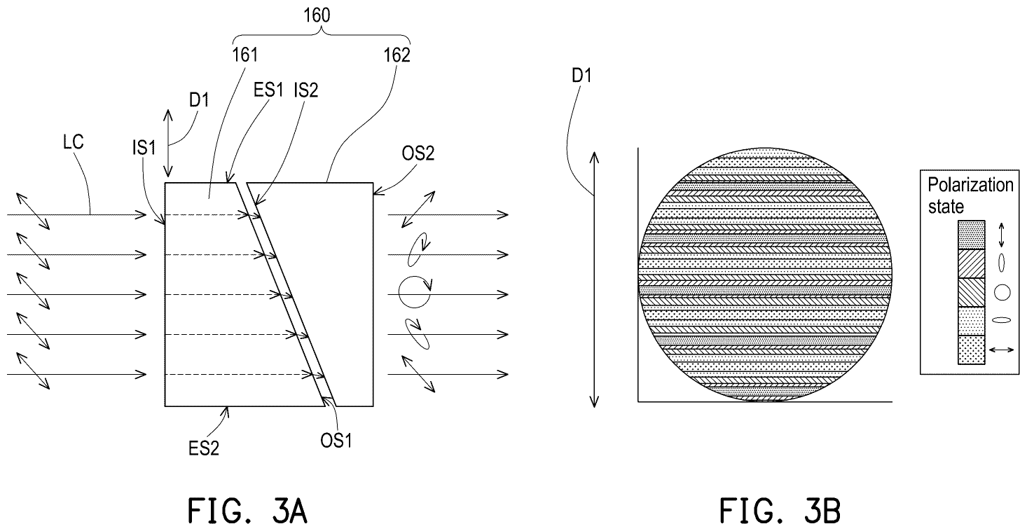

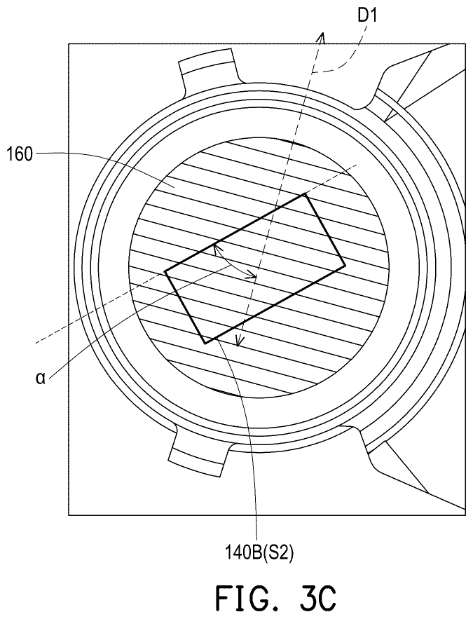

FIG. 3A is a schematic view of a principle of the depolarizer in FIG. 2. FIG. 3B is a schematic view of a polarization state distribution of the combined light beam in FIG. 3A after passing through the depolarizer. Referring to FIG. 3A and FIG. 3B, the depolarizer 160 is disposed on the transmission path of the combined light beam LC, and the depolarizer 160 has a light incident surface and a light exit surface. The light incident surface is parallel to the light exit surface. The depolarizer 160 includes a first optical element 161 and a second optical element 162. Furthermore, the first optical element 161 has an optical axis (not shown), and the combined light beam LC may be phase delayed in the direction of the optical axis after being incident on the first optical element 161. For example, in some embodiments, the first optical element 161 is crystalline quartz. Furthermore, when the combined light beam LC passes through the first optical element 161, the linear polarization direction thereof will be rotated by an angle or phase delayed in a specific direction. The size of this angle is related to the refractive index of the material and the thickness of the quartz which light passes through. Therefore, as long as these linear polarization beams pass through different positions of the crystalline quartz, the combined light beam LC will have different polarization states. In this way, the polarization states in the combined light beam LC can be disrupted, as shown in FIG. 3B. Furthermore, the first optical element 161 is wedge-shaped, and the thickness thereof changes in a gradient (gradually increases or decreases) along the direction (a thickness changing direction D1) perpendicular to the optical axis of the first optical element 161, so that the combined light beam LC can be made into a plurality of polarized light beams with different polarization states after passing through the first optical element 161 to eliminate the phenomenon of speckle.

Specifically, as shown in FIG. 3A, the first optical element 161 has a first light incident surface IS1, a first end surface ES1, a second end surface ES2, and a first light exit surface OS1. The first end surface ES1 and the second end surface ES2 are both connected to the first light incident surface IS1 and the first light exit surface OS1. The first light incident surface IS1 and the first light exit surface OS1 are not parallel to each other. The combined light beam LC can be incident on the first optical element 161 through the first light incident surface IS1. Furthermore, a first size of the first end surface ES1 is smaller than a second size of the second end surface ES2, and the first optical element 161 gradually changes from the first size to the second size in the thickness changing direction D1.

On the other hand, in the embodiment, a shape of the first optical element 161 and a shape of the second optical element 162 are geometrically symmetrical, and in a cross-sectional view of the depolarizer 160, the first optical element 161 and the second optical element 162 are both wedge-shaped. Furthermore, the second optical element 162 has a second light incident surface IS2 and a second light exit surface OS2 that are not parallel to each other. The first light exit surface OS1 is parallel to the second light incident surface IS2. The first light incident surface IS1 is parallel to the second light exit surface OS2. The first light incident surface IS1 of the first optical element 161 is the light incident surface of the depolarizer 160, and the second light exit surface OS2 of the second optical element 162 is the light exit surface of the depolarizer 160. Furthermore, the second optical element 162 is, for example, fused quartz, and has a refractive index close to the refractive index of crystalline quartz. In this way, the second optical element 162 can be configured to compensate for the deflection displacement of the light beam passing through the first optical element 161 and correct the transmission direction of the combined light beam LC. Of course, the disclosure is not limited thereto.

In the embodiment, there is a gap between the first light exit surface OS1 of the first optical element 161 and the second light incident surface IS2 of the second optical element 162. Furthermore, the first light exit surface OS1 of the first optical element 161 and the second light incident surface IS2 of the second optical element 162 are inclined at an angle (the angle is greater than 1 degree) relative to the thickness changing direction D1 as shown in FIG. 3A. Moreover, a bonding member (not shown) is disposed between the first light exit surface OS1 of the first optical element 161 and the second light incident surface IS2 of the second optical element 162. For example, in the embodiment, a bonding member (not shown) is an adhesive body, and the bonding member (not shown) is not located on the transmission path of the combined light beam LC, but located in the surrounding area of the depolarizer 160. The surrounding area surrounds the light passing area which the combined light beam LC passes through. In this way, the first optical element 161 and the second optical element 162 can be bonded. For example, in the embodiment, the outline of the surrounding area of the depolarizer 160 may be circular or square, but the disclosure is not limited thereto.

FIG. 3C is a schematic structural view of the depolarizer and the second light homogenizing element in FIG. 2. Referring to FIG. 3A to FIG. 3C at the same time, in some embodiments, the light incident surface of the depolarizer 160 and the light incident surface 140BI of the second light homogenizing element 140B are substantially parallel. There is an included angle α between the thickness changing direction D1 of the depolarizer 160 and any side of the second shape S2 of the light incident surface 140BI of the second light homogenizing element 140B. The included angle α may be greater than 0 degrees and less than 90 degrees. FIG. 3C shows the included angle between the long side of the second shape S2 and the thickness changing direction D1. To put it another way, the stripes perpendicular to the thickness changing direction D1 on the second light homogenizing element 140B in FIG. 3C can correspond to the distribution of the combined light beam LC of different polarization states in FIG. 3B. Through the deflection angle α of the second light homogenizing element 140B relative to the thickness changing direction D1 of the depolarizer 160, the combined light beam LC can be effectively reflected a plurality of times in the second light homogenizing element 140B, and the polarization state of the combined light beam LC can be destroyed to further homogenize the combined light beam LC, so that the light polarization state of an image light beam IB passing through a projection lens 300 can be evenly distributed, further eliminating the color block distribution, uneven color, and uneven brightness in the image formed by the image light beam IB, thereby effectively improving the image quality. In some embodiments, the included angle α is, for example, substantially 45 degrees, but the disclosure is not limited thereto.

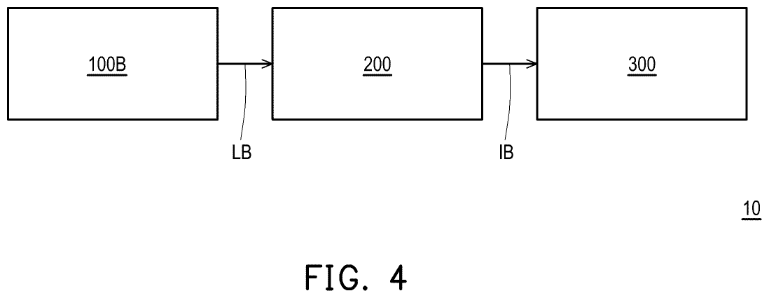

FIG. 4 is a schematic structural view of a projection device according to an embodiment of the disclosure. Referring to FIG. 4, a projection device 10 includes the light source system 100B, a light valve 200, and the projection lens 300. The light source system 100B is configured to provide the illumination light beam LB. The light valve 200 is disposed on the transmission path of the illumination light beam LB from the light source system 100B, and configured to convert the illumination light beam LB into the image light beam IB. The projection lens 300 is disposed on the transmission path of the image light beam IB, and configured to project the image light beam IB out of the projection device 10. In the embodiment, the number of the light valve 200 is one, but the disclosure is not limited thereto. In other embodiments, the number of the light valves 200 can also be plural. In addition, in the embodiment, the light valve 200 can be a digital micro-mirror device (DMD) or a liquid-crystal-on-silicon panel (LCOS panel). However, in other embodiments, the light valve 200 may also be a transmissive liquid crystal panel or other light beam modulators.

It is worth mentioning that the light source system 100B is applied to the projection device 10 as an illustration here, but the disclosure is not limited thereto. In other embodiments, the light source system 100A may also be applied to the projection device 10. Conventional laser projectors are prone to destroying the polarization state of polarized light due to internal optical elements, resulting in uneven color and brightness in the image. Following the above, when the light source system 100B is used, since the depolarizer 160 can effectively distribute the polarization state of the combined light beam LC evenly, the combined light beam LC passing through the depolarizer 160 can be regarded as unpolarized light, which can alleviate the above-mentioned problems of the conventional laser projectors. When the light source system 100B is applied in a projection device that uses polarized light to generate a three-dimensional (3D) image, a polarizer (not shown) can be added to the light exit side of the projection lens 300 to generate the polarized light (such as linear polarization). A plurality of projection devices 10 generate polarized light in different directions, and the user then wears corresponding polarized 3D glasses, so that the left eye and the right eye can respectively receive the image light beam IB of different polarization states and different viewing angles to generate a 3D image.

To sum up, in the light source system and projection device of the disclosure, since the first light homogenizing element has the deflection angle on the plane perpendicular to the optical axis of the second light beam, the shape of the light spot formed after the second light beam is converted into the fluorescent light beam also rotates corresponding to the deflection angle. The light spot of the rotated fluorescent light beam can substantially correspond to the shape of the light incident surface of the second light homogenizing element, thereby effectively increasing the number of reflections of the fluorescent light beam in the second light homogenizing element to generate the illumination light beam with good uniformity. In other words, through the interaction of the first light homogenizing element and the second light homogenizing element, the uniformity of the illumination light beam of the light source system and the projection device having the above-mentioned light source system can be effectively improved, and the uniformity of color and brightness of the image light beam is also improved, thereby improving the image quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source system, comprising:
a laser light source module, configured to provide a first light beam;
an excitation light source module, configured to provide a second light beam;
a light-combining element, disposed on a transmission path of the first light beam and the second light beam;
a first light homogenizing element, disposed between the excitation light source module and the light-combining element, wherein the first light homogenizing element is configured to receive and homogenize the second light beam from the excitation light source module to transmit the second light beam to the light-combining element, and a light exit surface of the first light homogenizing element has a first shape;
a wavelength conversion element, configured to receive the second light beam from the light-combining element and convert the second light beam into a fluorescent light beam, wherein the light-combining element is disposed between the first light homogenizing element and the wavelength conversion element, the light-combining element is configured to guide the fluorescent light beam from the wavelength conversion element and the first light beam from the laser light source module, so that the first light beam and the fluorescent light beam form a combined light beam; and
a second light homogenizing element, disposed on a transmission path of the combined light beam, and configured to receive the combined light beam and generate an illumination light beam, wherein a light spot formed by the fluorescent light beam on a light incident surface of the second light homogenizing element has the first shape, a shape of the light incident surface of the second light homogenizing element is a second shape, and the first shape substantially corresponds to the second shape,
wherein the first light homogenizing element has a deflection angle on a plane perpendicular to an optical axis of the second light beam.

2. The light source system according to claim 1, wherein the deflection angle is greater than 0 degrees and less than or equal to 10 degrees.

3. The light source system according to claim 1, further comprising a depolarizer disposed on the transmission path of the combined light beam and located between the light-combining element and the second light homogenizing element.

4. The light source system according to claim 3, wherein a light incident surface of the depolarizer and the light incident surface of the second light homogenizing element are substantially parallel, the depolarizer has a thickness changing direction, there is an included angle between the thickness changing direction and any side of the second shape, and the included angle is greater than 0 degrees and less than 90 degrees.

5. The light source system according to claim 1, wherein the laser light source module also comprises:
a laser light source, configured to generate the first light beam;
an auxiliary light source, configured to provide a third light beam; and
an auxiliary light source beam splitter, disposed on a transmission path of the first light beam and the third light beam, wherein the auxiliary light source beam splitter is configured to reflect the third light beam and allow the first light beam to pass through,
wherein the first light beam, the third light beam, and the fluorescent light beam form the combined light beam.

6. The light source system according to claim 5, wherein a number of the auxiliary light source is greater than a number of the laser light source, and the laser light source module further comprises:
a first beam splitter, disposed on a transmission path of the first light beam from the laser light source to the auxiliary light source beam splitter, wherein the first light beam comprises a first part and a second part, and the first beam splitter is configured to allow the first part of the first light beam to pass through and reflect the second part of the first light beam; and
a second beam splitter, disposed on a transmission path of the second part of the first light beam, and configured to reflect the second part of the first light beam, so that the second part of the first light beam is transmitted to the auxiliary light source beam splitter.

7. The light source system according to claim 5, further comprising:
a first lens group, disposed between the laser light source module and the light-combining element;
a second lens group, disposed between the wavelength conversion element and the light-combining element.

8. The light source system according to claim 1, further comprising a diffusion element disposed between the laser light source module and the light-combining element.

9. The light source system according to claim 1, further comprising a light-combining module disposed on a light exit side of the excitation light source module to combine a plurality of light beams emitted by the excitation light source module into the second light beam.

10. A projection device, comprising a light source system, a light valve, and a projection lens, wherein the light source system comprises:
a laser light source module, configured to provide a first light beam;
an excitation light source module, configured to provide a second light beam;
a light-combining element, disposed on a transmission path of the first light beam and the second light beam;
a first light homogenizing element, disposed between the excitation light source module and the light-combining element, wherein the first light homogenizing element is configured to receive and homogenize the second light beam from the excitation light source module to transmit the second light beam to the light-combining element, and a light exit surface of the first light homogenizing element has a first shape;
a wavelength conversion element, configured to receive the second light beam from the light-combining element and convert the second light beam into a fluorescent light beam, wherein the light-combining element is disposed between the first light homogenizing element and the wavelength conversion element, and the light-combining element is configured to guide the fluorescent light beam from the wavelength conversion element and the first light beam from the laser light source module, so that the first light beam and the fluorescent light beam form a combined light beam; and
a second light homogenizing element, disposed on a transmission path of the combined light beam, and configured to receive the combined light beam and generate an illumination light beam, wherein a light spot formed by the fluorescent light beam on a light incident surface of the second light homogenizing element has the first shape, a shape of the light incident surface of the second light homogenizing element is a second shape, and the first shape substantially corresponds to the second shape,
wherein the first light homogenizing element has a deflection angle on a plane perpendicular to an optical axis of the second light beam,
wherein the light valve is disposed on a transmission path of the illumination light beam of the light source system and configured to convert the illumination light beam into an image light beam, and
wherein the projection lens is disposed on a transmission path of the image light beam and configured to project the image light beam out of the projection device.

11. The projection device according to claim 10, wherein the deflection angle is greater than 0 degrees and less than or equal to 10 degrees.

12. The projection device according to claim 10, further comprising a depolarizer disposed on the transmission path of the combined light beam and located between the light-combining element and the second light homogenizing element.

13. The projection device according to claim 12, wherein a light incident surface of the depolarizer and the light incident surface of the second light homogenizing element are substantially parallel, the depolarizer has a thickness changing direction, there is an included angle between the thickness changing direction and any side of the second shape, and the included angle is greater than 0 degrees and less than 90 degrees.

14. The projection device according to claim 10, wherein the laser light source module further comprises:
a laser light source, configured to generate the first light beam;
an auxiliary light source, configured to provide a third light beam; and
an auxiliary light source beam splitter, disposed on a transmission path of the first light beam and the third light beam, wherein the auxiliary light source beam splitter is configured to reflect the third light beam and allow the first light beam to pass through,
wherein the first light beam, the third light beam, and the fluorescent light beam form the combined light beam.

15. The projection device according to claim 14, wherein a number of the auxiliary light source is greater than a number of the laser light source, and the laser light source module further comprises:
a first beam splitter, disposed on a transmission path of the first light beam from the laser light source to the auxiliary light source beam splitter, wherein the first light beam comprises a first part and a second part, and the first beam splitter is configured to allow the first part of the first light beam to pass through and reflect the second part of the first light beam; and
a second beam splitter, disposed on a transmission path of the second part of the first light beam, and configured to reflect the second part of the first light beam, so that the second part of the first light beam is transmitted to the auxiliary light source beam splitter.

16. The projection device according to claim 14, further comprising:
a first lens group, disposed between the laser light source module and the light-combining element;
a second lens group, disposed between the wavelength conversion element and the light-combining element.

17. The projection device according to claim 10, further comprising a diffusion element disposed between the laser light source module and the light-combining element.

18. The projection device according to claim 10, further comprising a light-combining module disposed on a light exit side of the excitation light source module to combine a plurality of light beams emitted by the excitation light source module into the second light beam.
